(19) United States
(12) Patent Application Publication
(10) Pub. No.: US 2010/0201072 A1
(43) Pub. Date: Aug. 12, 2010

(54) ONE PIECE SHAFT SEAL APPARATUS AND METHOD

(76) Inventors: Jeffrey A. Wians, Mebane, NC (US); Scott J. Kaskawitz, Burlington, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/366,986

(22) Filed: Feb. 6, 2009

(51) Int. Cl. F16J 15/32; F16J 15/34

(52) U.S. Cl. 277/307; 277/562

(57) ABSTRACT

A one-piece shaft seal apparatus and related method are disclosed for use in machines having a rotating shaft and a rolling-element bearing. The integral shaft seal apparatus can include a substantially rigid, annular frame secured between a machine support structure and a rolling-element bearing surrounding a rotatable shaft, and some combination of a bearing seal portion extending from the frame, a housing seal portion that can be secured between the rolling-element bearing and the machine support structure, and a shaft seal portion extending between the frame and the shaft, wherein fluid in the race can be separated from fluid sealed by the shaft seal portion. The bearing seal portion can snap in place between the races of the bearing, while the shaft seal portion can be at least partially in fluid-tight contact with the shaft.

### TECHNICAL FIELD

The subject matter disclosed herein relates generally to radial shaft seals. More particularly, the subject matter disclosed herein relates to one-piece shaft seal apparatuses and methods such as those for use in machines having a rotating shaft and a rolling-element bearing.

### BACKGROUND

Radial shaft seals are used between rotating and non-rotating machine components to provide fluid containment or separation of the rotary elements.

Common examples include engine seals, transmission seals, and bearing seals, among many others. Commonly, the shaft seal portion will consist of a rigid support ring adapted to fit in fluid-tight relation within a cylindrical bore in the non-rotating housing. The ring holds an elastomeric sealing element in fluid-tight contact with the outer surface of the rotating shaft (or a wear ring supported thereon). Even with this sealing, however, rotating components can still be affected by any dirt and debris that manages to get past the sealing element. As a result, multiple seals can advantageously be used to further protect sensitive rotary elements.

FIGS. 1 and 2 illustrate an arrangement that has existed in the past for a system including radial shaft and bearing seals that protect both the introduction of dirt and debris toward a rolling-element bearing and further between the races of the bearing. Although typical engines now may or may not include the bearing seal in association with the rotating shaft, FIGS. 1 and 2 illustrate a prior art arrangement that does include a bearing seal. As shown, a rolling-element bearing generally designated 12 is supported in a machine support structure 14 (e.g., an engine housing). Bearing 12 can include an inner race 12a, an outer race 12b, and a plurality of rolling elements 16 (e.g., balls, rollers) positioned therebetween. Bearing 12 can serve to provide rotating support for a shaft 18, such as a crank shaft for a lawnmower, tiller, or the like. Two separate seals, a race seal 20 and a shaft seal 22, can be provided for preventing oil from leaking from the system, although as noted above, typical engines now can have a bearing such as bearing 12 but may or may not include a seal such as shaft seal 22. In addition, this arrangement helps to prevent dirt and debris from being introduced and damaging shaft 18 and/or bearing 12. These benefits come at the expense of the additional complexity of multiple seals that must be inserted and aligned within the system.

### SUMMARY

In accordance with this disclosure, a novel one-piece shaft seal apparatus and related method are provided. In one aspect, a novel flywheel one-piece shaft seal apparatus and method are provided for sealing against at least the rotatable shaft and either a housing and/or a bearing associated with the shaft. Such an apparatus and method can maintain bearing fluid separate from shaft fluid in a machine with a rotatable shaft and bearing.

Some of the aspects of the subject matter disclosed herein having been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a side sectional view of a shaft and bearing arrangement with separate oil and race seals according to a configuration found in the prior art;

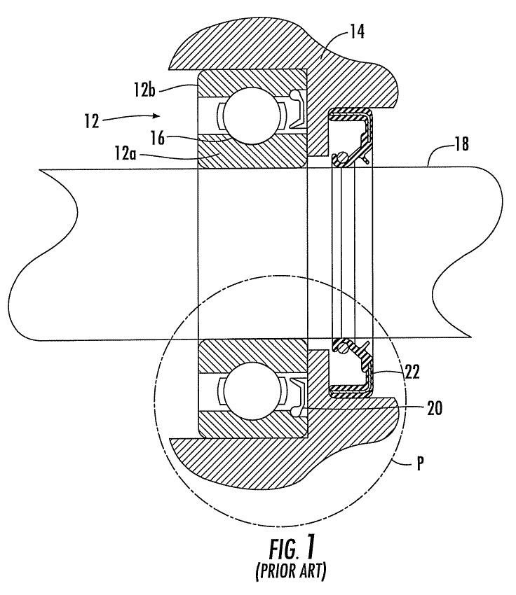

FIG. 2 is a close-up view of portion P of the configuration shown in FIG. 1;

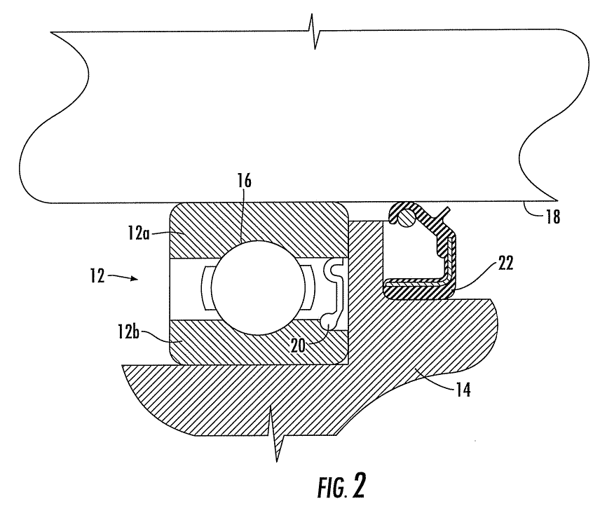

FIGS. 3A and 3B are top and bottom perspective views, respectively, of a one-piece shaft seal apparatus according to an embodiment of the presently disclosed subject matter;

FIG. 4 is an elevational side view of the one-piece shaft seal apparatus shown in FIGS. 3A and 3B;

FIG. 5 is side sectional view of a shaft and bearing arrangement with a one-piece shaft seal apparatus according to an embodiment of the presently disclosed subject matter; and

FIG. 6 is a close-up view of portion P of the shaft and bearing arrangement shown in FIG. 5.

### DETAILED DESCRIPTION

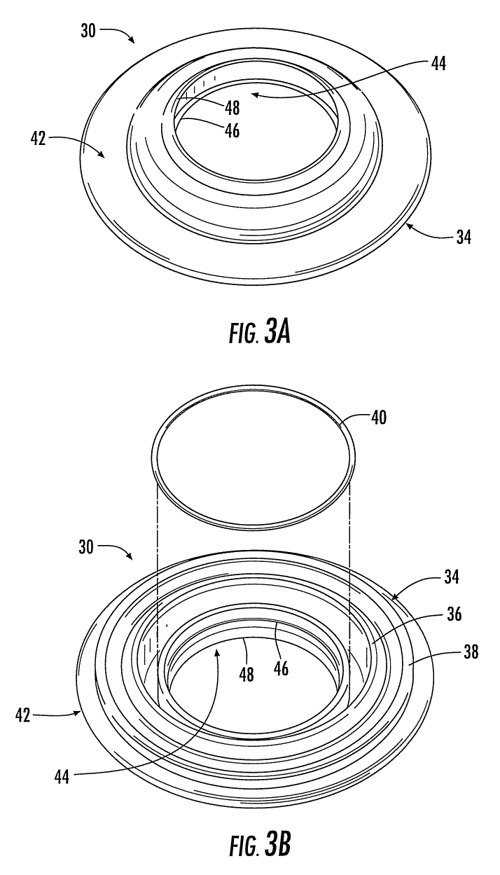

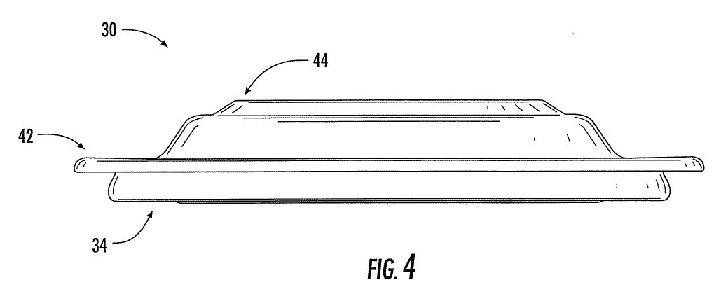

The presently disclosed subject matter provides a radial shaft seal that can provide a shaft seal along with either or both a bearing seal and a housing seal in a single, integral seal apparatus, generally designated 30, which is shown for example in FIGS. 3A, 3B, and 4. Seal apparatus 30 can be radial in shape and be radially disposed about and around a central area adapted for receiving a shaft therethrough. Seal apparatus 30 can include a bearing seal portion generally designated 34, which can itself have a first bearing seal lip 36 and a second bearing seal lip 38. Although seal apparatus 30 can be used to replace the bearing seal in situations where an existing bearing already includes a separate bearing seal, seal apparatus 30 can also be used where an existing bearing does not already use a bearing seal.

Seal apparatus 30 can further include a shaft seal portion generally designated 44, which can have a first shaft seal lip 46 and a second shaft seal lip 48. In addition to shaft seal portion 44, seal apparatus 30 can further provide a housing seal portion, generally designated 42, which can be provided in combination with or in place of bearing seal portion 36. The combination of these multiple seal portions (e.g., some combination of bearing seal portion 34, housing seal portion 42, and shaft seal portion 44) on seal apparatus 30 can provide a single sealing element to provide sealing of both a shaft and a bearing positioned about the shaft, thereby providing multiple layers of defense against intrusion by dust, dirt, or other contaminants.

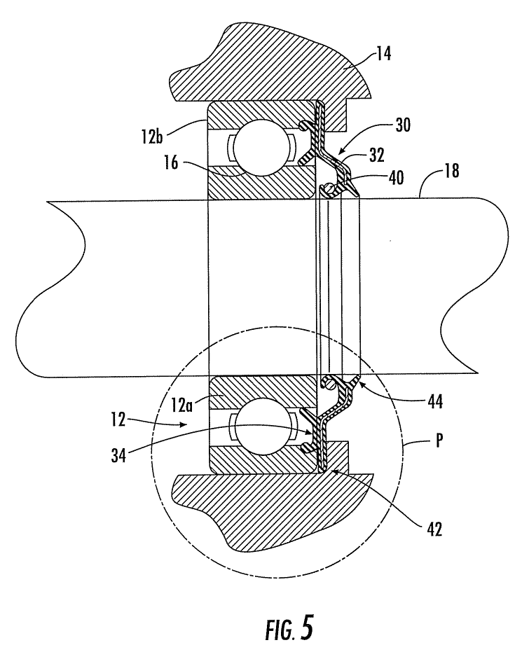

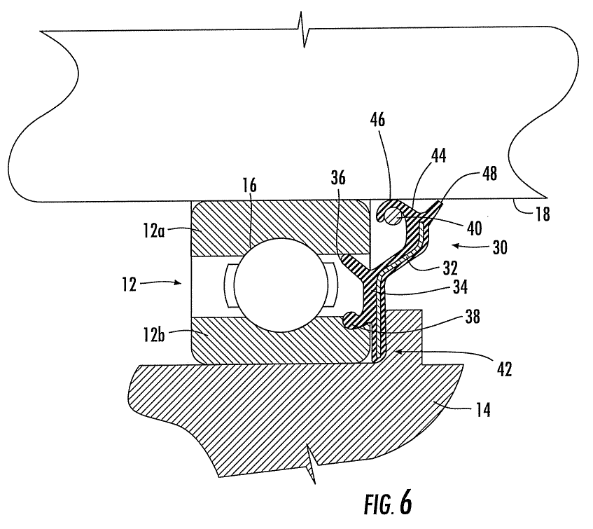

Referring to FIGS. 5 and 6 particularly, the mechanical system into which seal apparatus 30 can be used can be at least similar to the typical configuration discussed above. For example, rolling-element bearing 12 can be supported in machine support structure 14. Bearing 12 can include inner race 12a, outer race 12b, and a plurality of rolling elements such as rolling elements 16 positioned therebetween. Seal apparatus 30 can include a body or frame 32 that can be annular in shape and define a central opening therethrough. Frame 32 can be substantially rigid and can be secured as shown in FIGS. 5 and 6 against and between at least a portion of machine support structure 14 and rolling-element bearing 12. For instance, frame 32 can be a steel frame (e.g., sheet steel formed into a desired shape) that can be over-molded with a rubber layer. Alternatively, frame 32 can be formed entirely from an elastomeric material without a metal skeleton. Regardless of the materials used, frame 32 can serve to provide structural support for seal apparatus 30, helping seal apparatus 30 to withstand deformation due to the operating conditions.

As noted above, seal apparatus 30 can further include a bearing seal portion 34, which can extend from frame 32 to bearing 12. Specifically, bearing seal portion 34 can be sized and structured to snap in place between rotatable inner race 12a of bearing 12 and stationary outer race 12b of bearing 12. In this configuration, bearing seal portion 34 can function to separate fluid between the races 12a and 12b from fluid sealed by shaft seal portion 44, thereby minimizing dirt, oil, and water ingress that can result in damage and premature failure of bearing 12.

More specifically and with reference to FIG. 6, bearing seal portion 34 can for example include a first bearing seal lip 36 that when in place can be in fluid-tight contact with inner race 12a. First bearing seal lip 36 can be in close enough contact with inner race 12a to minimize the introduction of dirt and debris into bearing 12, but not so close that it causes enough friction to significantly affect the efficiency of bearing 12. Bearing seal portion 34 can also include a second bearing seal lip 38 that when in place can engage outer race 12b. Because neither outer race 12b nor seal apparatus 30 are designed to rotate with shaft 18, second bearing seal lip 38 can be permitted to create tight contact with outer race 12b.

Alternatively, in some embodiments, bearing seal portion 34 need not completely seal the fluid contained between races 12a and 12b within rolling element bearing 12. In such situations, bearing seal portion 34 can purely serve as a bearing engagement portion for securing seal apparatus 30 in place between machine support structure 14 and rolling-element bearing 12. In either configuration, seal apparatus 30 can be designed to be installed at the same time as bearing 12, which can help to reduce the complexity and time of the installation process.

In addition, seal apparatus 30 can include a housing seal portion 42 that can be secured between rolling-element bearing 12 and machine support structure 14. As noted above, housing seal portion 42 can be provided in place of bearing seal portion 34 or in combination with bearing seal portion 34. As a result, regardless of whether bearing seal portion 34 provides complete sealing of fluid within rolling-element bearing 12, a seal is created between rolling-element bearing 12 and machine support structure 14.

Seal apparatus 30 can further include a shaft seal portion 44 that can extend between frame 32 and shaft 18. Specifically, shaft seal portion 44 can, when in place, have a first shaft seal lip 46 that can be in fluid-tight contact with shaft 18. First shaft seal lip 46 can be sized and structured such that it can provide the requisite interference fit to snugly surround rotating shaft 18, thereby providing a barrier to substantially any dust or debris that would otherwise be able to pass to bearing 12. In addition, the shaft seal portion 44, and first shaft seal lip 46 in particular, can be designed to have a hydrodynamic surface contour to help maintain first shaft seal lip 46 in contact with shaft 18 while minimizing wear. Shaft seal portion 44 can further have a second shaft seal lip 48 that can when in place be in fluid-tight contact with shaft 18 to provide further prevent leakage from seal apparatus 30 as well as to protect the sealing interface from dust and other fine solid contaminants. Generally, second shaft seal lip 48 can be spaced apart from first shaft seal lip 46, and a suitable lubricant in the space between first shaft seal lip 46 and second shaft seal lip 48 can reduce wear and delay corrosion.

Regardless of the design of shaft seal portion 44, a snug fit of shaft seal portion 44 onto rotating shaft 18 can potentially result in rapid wearing of shaft seal portion 44, which can in turn result in leakage past shaft seal portion 44. Accordingly, such leakage can be minimized and controlled by a combination of features. First, a retaining element 40 can be provided for holding first shaft seal lip 46 in contact with shaft 18, compensating for lip wear and elastomer material changes. In particular, retaining element 40 can be a substantially circular, resilient element, such as an endless coil garter spring ring or a spiral spring, which can extend at least partially around shaft seal portion 44. Specifically, as is illustrated in an exploded view aspect of FIG. 3B, retaining element 40 can be positioned about first shaft seal lip 46 of shaft seal portion 44 (shown in FIG. 3 detached from seal 30). Further, as is depicted in FIGS. 5 and 6, shaft seal portion 44 can be configured to support retaining element 40 about first shaft seal lip 46. In this arrangement, retaining element 40 can apply a predefined radial force to continuously and resiliently urge first shaft seal lip 46 into contact with rotating shaft 18.

Additionally, to help shaft seal portion 44 to be able to seal efficiently over a long period of time, first shaft seal lip 46 can be lubricated to prevent physical contact between the components, thereby diminishing the wear of shaft seal portion 44. Lubrication can further reduce friction in the contact as well as wear to first shaft sealing lip 46 and the surface of shaft 18. To further prevent dry running of first shaft sealing lip 46 made of standard materials, shaft 18 can itself be coated with a suitable lubricant when seal apparatus 30 is being installed. As an added benefit, the lubricant can also transport at least some of the heat generated by friction between shaft seal portion 44 and shaft 18 away from the interface.

In the normal operation of low friction roller bearings such as bearing 12, some small amount of lubricant will likely leak past first shaft sealing lip 46. Some amount of leakage can beneficially serve to lubricate first shaft sealing lip 46. In applications where seal apparatus 30 has to retain oil or grease, this lip lubrication can often be provided by a natural pumping action caused by the design of bearing 12. Examples of some rolling bearings that exhibit such automatic lubricating designs include angular contact ball bearings, tapered roller bearings, and spherical roller thrust bearings.

Of course, this pumping action may not always provide an ideal amount of lubrication to shaft seal portion 44. In particular configurations, for instance, first shaft sealing lip 46 can be starved of lubricant or subjected to excessive quantities of lubricant. Accordingly, steps can be taken at the design stage in order to ensure either that lubricant actually reaches the interface between shaft seal portion 44 and shaft 18, or that excess quantities are removed. For example, the shape of shaft seal portion 44 can be designed to provide optimal leakage past shaft seal portion 44. Specifically, the angles at which first shaft sealing lip 46 contacts shaft 18 can be designed such that a pressure distribution is created at the contact point between shaft 18 and seal apparatus 30. This pressure distribution can be the result of the air side angle (i.e., away from bearing 12) generally being smaller than the oil side angle (i.e., near bearing 12). In general, the shallower the slope on the oil side of seal 30 is, the “wetter” seal apparatus 30 will run. In addition, retaining element 40 can be positioned such that it is biased to the air side of first shaft sealing lip 46.

In applications where lubricants are not being sealed, grease or oil can be supplied separately so that first shaft sealing lip 46 can be lubricated. In cases where seal apparatus 30 includes second shaft seal lip 48, it may be sufficient to provide an initial fill of grease between first shaft seal lip 46 and second shaft seal lip 48.

The presently disclosed subject matter provides a method of maintaining bearing fluid separate from shaft fluid in a machine with a rotatable shaft 18 and a bearing, such as a rolling element bearing 12. The method can include positioning a one-piece bearing and oil seal 30 around rotatable shaft 18, seal 30 including a shaft seal portion 44 and a bearing seal portion 34. The method can further include sealing shaft seal portion 44 against shaft 18 and sealing bearing seal portion 34 against bearing 12. As noted above, bearing seal portion 34 can be adapted for snapping in place between a stationary outer race 12b of bearing 12 and a rotatable inner race 12a of bearing 12.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A one-piece bearing and oil seal apparatus for sealing against a rotatable shaft and a bearing associated with the shaft, the bearing and oil seal apparatus comprising:
an annular frame configured for positioning around the rotatable shaft;
the annular frame having a shaft seal portion for sealing against the shaft and an integral bearing seal portion for sealing against the bearing; and
the bearing seal portion configured for snapping in place between a stationary outer race of the bearing and a rotatable inner race of the bearing;
whereby the bearing seal portion is adapted for maintaining bearing fluid separate from shaft fluid sealed by the shaft seal portion.

2. The bearing and oil seal apparatus of claim 1, wherein the annular frame is substantially rigid.

3. The bearing and oil seal apparatus of claim 1, wherein the annular frame comprises a steel frame over-molded with a rubber layer.

4. The bearing and oil seal apparatus of claim 1, wherein the annular frame is secured between a machine support structure and a bearing surrounding a rotatable shaft.

5. The bearing and oil seal apparatus of claim 1, wherein the bearing seal portion comprises a first bearing seal lip engaging the outer race of the bearing and a second bearing seal lip in fluid-tight contact with the inner race of the bearing.

6. The bearing and oil seal apparatus of claim 1, wherein the shaft seal portion comprises a first shaft seal lip in fluid-tight contact with the shaft.

7. The bearing and oil seal apparatus of claim 6, wherein the shaft seal portion further comprises a second shaft seal lip in fluid-tight contact with the shaft, the second shaft seal lip being spaced apart from the first shaft seal lip.

8. The bearing and oil seal apparatus of claim 1, comprising a retaining element holding the first shaft seal lip in contact with the shaft.

9. The bearing and oil seal apparatus of claim 8, wherein the retaining element is one of a spiral spring or a garter spring.

10. The bearing and oil seal apparatus of claim 1, comprising a housing seal portion configured for positioning between the bearing and a machine support structure.

11. A bearing and oil seal system for a rotatable shaft of a machine, the system comprising:
a rotatable shaft;
a stationary machine support structure positioned about the shaft, the machine support structure including a flange extending toward the shaft;
a rolling-element bearing positioned between the shaft and the machine support structure, the bearing comprising a rotatable inner race positioned about the shaft and a stationary outer race secured to the machine support structure; and
a one-piece bearing and oil seal comprising:
an annular frame configured for positioning around the rotatable shaft;
the annular frame having a shaft seal portion for sealing against the shaft and an integral bearing seal portion for sealing against the bearing; and
the bearing seal portion configured for snapping in place between a stationary outer race of the bearing and a rotatable inner race of the bearing;
whereby the bearing seal portion is adapted for maintaining bearing fluid separate from shaft fluid sealed by the shaft seal portion.

12. The bearing and oil seal system of claim 1 1, wherein the annular frame is secured between the machine support structure flange and the rolling-element bearing.

13. The bearing and oil seal system of claim 111, wherein the shaft seal portion comprises a first shaft seal lip in fluid-tight contact with the shaft.

14. The bearing and oil seal system of claim 11, wherein the bearing seal portion comprises a first bearing seal lip engaging the outer race of the bearing and a second bearing seal lip in fluid-tight contact with the inner race of the bearing.

15. A method of maintaining bearing fluid separate from shaft fluid in a machine with a rotatable shaft and bearing, the method comprising:
positioning a bearing and oil seal around the rotatable shaft, the one-piece bearing and oil seal including an integral shaft seal portion and a bearing seal portion;
sealing the shaft seal portion against the shaft; and
snapping the bearing seal portion in place between a stationary outer race of the bearing and a rotatable inner race of the bearing to seal the bearing seal portion against the bearing.

16. A one-piece shaft seal apparatus for sealing against a rotatable shaft of a machine, the shaft seal apparatus comprising:
an annular frame configured for positioning around the rotatable shaft;
the annular frame having a shaft seal portion for sealing against the shaft and an integral housing seal portion for sealing against a machine support structure of the machine; and
a bearing engagement portion configured for snapping in place between a stationary outer race of the bearing and a rotatable inner race of the bearing.
